(19) United States
(12) Patent Application Publication
(10) Pub. No.: US 2014/0156603 A1
(43) Pub. Date: Jun. 5, 2014

(54) METHOD AND AN APPARATUS FOR SPLITTING AND RECOVERING DATA IN A POWER SYSTEM

(71) Applicants: State Grid Corporation of China, Beijing (CN); Jiangsu Electric Power Company, Nanjing (CN); China Realtime Database Co. Ltd., SGEPRI, Nanjiang (CN); State Grid Suzhou Power Supply Company, Suzhou (CN)

(72) Inventors: Jiaqing Zhao, Suzhou (CN); Jinghu Zhao, Suzhou (CN); Dawei Su, Suzhou (CN); Keheng Zhang, Suzhou (CN); Huiqun Li, Suzhou (CN); Chunlei Xu, Suzhou (CN); Kejun Qian, Suzhou (CN); Xuesong Huo, Suzhou (CN); Yuzhi Zhou, Suzhou (CN); Hong Yang, Suzhou (CN); Chun Li, Suzhou (CN); Yang Lv, Suzhou (CN); Hongen Di, Suzhou (CN); Sheng Tang, Suzhou (CN); Peijue Li, Suzhou (CN)

(73) Assignees: State Grid Corporation of China, Beijing (CN); Jiangsu Electric Power Company, Nanjing (CN); China Realtime Database Co. Ltd., SGEPRI, Nanjiang (CN); State Grid Suzhou Power Supply Company, Suzhou (CN)

(21) Appl. No.: 14/058,443

(22) Filed: Oct. 21, 2013

(30) Foreign Application Priority Data
Dec. 3, 2012 (CN) CN201210510787.7

(51) Int. Cl. G06F 17/30

(52) U.S. Cl. CPC G06F 17/30289
USPC 707/674

(57) ABSTRACT

A method and an apparatus for splitting and recovering data in a power system are provided in the invention. The method includes the steps of setting a first database and a data recovery unit in a platform layer of the power system. The first database runs in a memory of the power system and is composed of the real-time image in the memory of a grid model and static parameters of a second database. The first database is used to provide the inquiry service of the grid model and static parameters for the power system. The data recovery unit is responsible for all of the associated read-write operations with the second database. After data are written into, the data recovery unit stores the data as historical data according to the time scale characters, and writes the historical data to the second database when the second database is normal.

### RELATED APPLICATIONS

This application claims priority to CN application no. CN201210510787.7 filed Dec. 3, 2012 under 35 U.S.C. 119 (a).

### FIELD OF THE INVENTION

The invention relates to the field of a power system, especially to a method and an apparatus for splitting and recovering data in a power system.

### DESCRIPTION OF THE RELATED ART

Databases (herein referring to commercial databases, i.e., relational databases) are not used in earlier power systems in which the data storage is managed by utilizing the private formats of files. In those power systems the information search is difficult; in addition, the information reuse is difficult due to lack of an open interface. With the development of the database technology and the power dispatching automation systems, databases are gradually used by domestic power dispatching automation system. This results in a significant improvement in the abilities of data storage and data retrieval. However, the number of fault locations will increase with the increasing number of the sections, and sometimes the database management system can not work well due to faults thereof. When the database does not work well due to faults, the data retrieval service can not be efficiently provided, which will influence the basic functions of the power systems, such as tele-signalization, tele-metering, tele-control and tele-regulation, as well as the continuity and integrity of the data, and thus the real-time data can not be stored as historical data. Consequently, an appropriate method is urgently needed to solve the above problem.

### SUMMARY OF THE INVENTION

To effectively isolate database faults in a power system, a method and an apparatus for splitting and recovering data in a power system are provided in the invention. By means of the invention, the basic functions of the power system will not be influenced by the database faults, and the power system can still provide inquiry service about the grid model and static parameters when the second database fails to work well, and the historical data can recover successfully when the second database returns to normal, thus, the continuity and integrity of the data can be ensured.

According to one aspect of the invention, a method for splitting and recovering data in a power system is provided, which comprises:

a database access layer calling interfaces TableOpen and TableGet corresponding to a first database to inquire in the first database when the database access layer receives a read request to a grid model and static parameters, wherein the input parameters of TableOpen are const char* app_name and const int table_no, and the input parameter of TableGet is char*field_name, and the output parameters of TableGet are char**field_buf_ptr and intbufsize, and

the database access layer calling an interface SelectSql corresponding to a second database to inquire in the second database by means of a data recovery unit DB_SERVICE when the database access layer receives a read request to historical data, wherein the input parameter of SelectSql is constchar*sql_str, and the output parameters of SelectSql are TSelectResultStru_outout_select_result and SEQDBErrorStru_outout_db_error,

wherein the first database and the data recovery unit DB-SERVICE are set in a platform layer of the power system, and the first database and a second database constitute the whole database environment of the power system, the first database runs in the memory of the power system, which is consisted of the real-time image in the memory of a grid model and static parameters of the second database, the grid model, static parameters and historical data are stored in the second database, the access interfaces of the first and second databases are encapsulated in a database access layer, the data recovery unit DB-SERVICE is responsible for all of the associated read-write operations with the second database: the data recovery unit DB_SERVICE calling a main thread of a service process db_commit to write the received historical data with time scale characters into different files one by one when it receives a write request, and storing these files in a hard drive according to time to form a set of file sequence, and calling another thread of the service process db_commit to judge the state of the second database, such that the another thread can access and parse the file sequence to write its content to the second database if the second database is normal, or otherwise the another thread be into a state of loop waiting,

the data recovery unit DB-SERVICE calling a synchronization program DB_Modify_Server to write the real-time data from the first database to the second database as the historical data when it receives a synchronization request from the second database, and calling the synchronization program DB_Modify_Server to access the grid model and static parameters of the second database to update the first database when it receives a synchronization request from the first database, and

the accesses of the grid model, static parameters and historical data are encapsulated into different services in the data recovery unit DB_SERVICE.

According to another aspect of the invention, an apparatus for splitting and recovering data is provided, which comprises:

a first database, a data recovery unit DB_SERVICE, and a second database, wherein,

the first database and the data recovery unit DB-SERVICE are set in a platform layer of the power system, and the first database and a second database constitute the whole database environment of the power system,

the first database runs in the memory of the power system, which is consisted of the real-time image in the memory of a grid model and static parameters of the second database,

the grid model, static parameters and historical data are stored in the second database,

the access interfaces of the first and second databases are encapsulated in a database access layer,

the first database is used to call its corresponding interfaces TableOpen and TableGet to inquire when the database access layer receives a read request to the grid model and the static parameters, the input parameters of TableOpen are const char* app_name and const int table_no, and the input parameter of TableGet is char*field_name, the output parameters of TableGet is char**field_buf_ptr and intbufsize,

the first database is also used to write the real-time data of the first database to the second database as the historical data by means of a synchronization program DB_Modify_Server of the data recovery unit DB_SERVICE,

the second database is used to call its corresponding interface SelectSql to inquire by means of the data recovery unit DB_SERVICE when the database access layer receives a read request to the historical data, the input parameter of SelectSql being constchar*sql_str, the output parameters being TSelectResultStru_outout_select_result and SEQDBErrorStru_outout_db_error, and the second database is also used to access the grid model and static parameters of the second database to update the first database by means of the synchronization program DB_Modify_Server of the data recovery unit DB_SERVICE,

the data recovery unit DB_SERVICE set in a platform layer of the power system with the first database is responsible for all of the associated read-write operations with the second database, and the data recovery unit DB_SERVICE encapsulates the accesses of the grid model, static parameters and historical data into different services, and

the data recovery unit DB-SERVICE is used for calling a main thread of a service process db_commit to write the received historical data with time scale characters into different files one by one when it receives a write request, and storing these files in a hard drive according to time to form a set of file sequence, and calling another thread of the service process to judge the state of the second database, such that another thread can access and parse the file sequence to write its content into the second database if the second database is normal, or otherwise the another thread be into the state of loop awaiting.

As compared with the prior art, according to the specific embodiment of the invention, the beneficial effects of the invention are provided as follows.

In the invention, the first database in which a grid model and static parameters are stored is set in a platform layer of the power system, therefore, the high-speed access to the grid model and static parameters can be achieved in the power system, and when the second database fails to work well due to faults, the original grid model and static parameters still can be accessed by means of the first database, thus ensuring the basic functions of power system. Furthermore, a data recovery unit is also set in the platform of the power system, and it stores the historical data according to the time scale characters upon receiving a write request and writes the historical data into the second database, thus ensuring the continuity and integrity of the data.

### BRIEF DESCRIPTION OF THE DRAWINGS

FIG. 1 is a drawing showing the typical database environment of the power system according to the invention;

FIG. 2 is a flow chart showing the processing of a write request for the data recovery unit.

### DESCRIPTION OF THE PREFERRED EMBODIMENTS

The present invention will be described hereinafter with reference to the accompanying drawings. It is to be noted, however, that the drawings are given only for illustrative purpose and therefore not to be considered as limiting of its scope, for the invention may admit to other equally effective embodiments.

In order to describe the invention more clearly, the terms used in the following embodiments are explained herein firstly.

The second database means a relational database in the invention, which provides both data storage services and data retrieval services, and in which a grid model, static parameters and historical data are stored.

The grid model is an abstract description of main objects and properties thereof of the power system, for example a substation, transformer, busbar, and circuit breaker or the like.

The static parameters are the configuration parameters needed for the normal operation of the power dispatching automation system, such as start-stop configuration of each process, the source address of system data, the style of the system interface or the like.

The historical data means sampling data which rapidly grows over time during the operation of the grid, wherein the data are called real-time data when they are sampled from a sampling device, and called historical data when they are stored in the second database. The historical data include various dynamic data, for example telemetry data, tele-signaling change data and warning data.

The first embodiment of the present invention provides a method for splitting and recovering data in a power system, particularly for isolating the fault of a second database in the system. The power system should support the database environment which is constituted by a first database and a second database in the present invention.

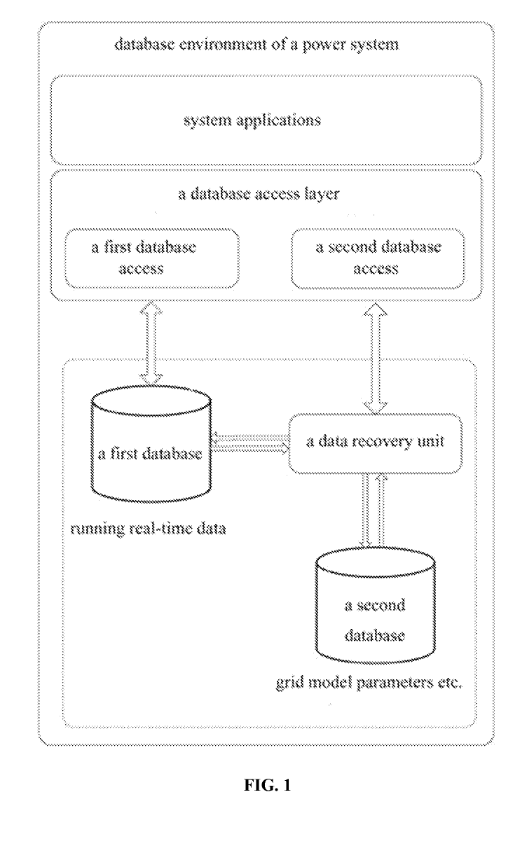

As shown in FIG. 1, a first database is set in a platform layer of the power system, thus, the whole database environment of the power system is constituted by the first database and the second database. Specifically, an access interface of the first database is added in a database access layer, the access interface of the first database and the access interface of the original database (i.e., a second database) are encapsulated in a same database access layer, and thus the database environment is transparent to the application in the power system.

The first database runs in a memory of the system, which is consisted of the real-time image in the memory of a grid model and static parameters of the second database. The data synchronization between the first database and second database is performed by a synchronization program DB_Modify_Server. Specifically, the synchronization program DB_Modify_Server writes the real-time data of the first database to the second database for storing as historical data, and accesses the grid model and static parameters of the second database to update the first database.

In an embodiment of the present invention, the grid model and static parameters of the second database can be uploaded to the first database by the synchronization program DB_Modify_Server when the first database runs for the first time. In subsequent process, the synchronization can be performed periodically or according to the requirements of the first database by the synchronization program DB_Modify_Server.

In the present invention, the database access layer calls interfaces TableOpen and TableGet corresponding to the first database to inquire in the first database, when it receives a read request to the grid model and the static parameters. The input parameters of TableOpen are const char* app_name (the application name) and const int table_no (number of the memory database table), and the input parameter of TableGet is char*field_name (domain name of the memory database table), the output parameters of TableGet are char**field_buf_ptr (memory space of the output data) and intbufsize (memory size). Consequently, due to the added first database, the high-speed access requirement to the grid model and static parameters is met in the power system, and the data (such as grid model and static parameters) still can be accessed from the first database when the second database fails to work well.

As shown in FIG. 1, a data recovery unit DB_SERVICE is also set in the platform layer of the power system. The data recovery unit DB_SERVICE is particularly set between the access interface of the second database and the second database, and is responsible for all of the associated read-write operations with the second database. In the data recovery unit DB_SERVICE the accesses of the grid model, static parameters and historical data are encapsulated into different services.

The database access layer calls interface SelectSql corresponding to the second database to inquire in the second database by means of the data recovery unit DB_SERVICE, when it receives a read request to the historical data. The input parameter of SelectSql is constchar*sql_str (a sql statement for inquiring data), the output parameters of SelectSql are TSelectResultStru_outout_select_result (output dataset) and SEQDBErrorStru outout_db_error (string collection of result).

The data recovery unit DB_SERVICE uploads the corresponding data from the second database to the first database, when it receives a synchronization request to the grid model and static parameters from the first database.

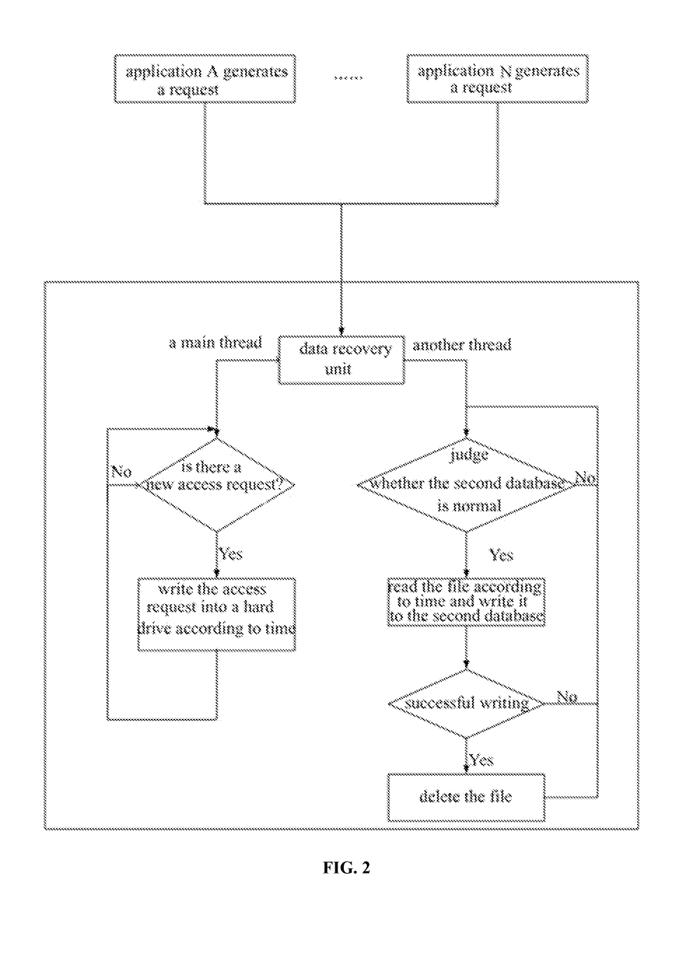

The FIG. 2 shows the basic process of write requests for the data recovery unit DB_SERVICE. Application programs transmit write requests of historical data to a service process db_commit which is multithreaded, the main thread of the service process db_commit determines whether a new request is received, when a write request is received, the main thread writes the historical data with time scale characters into different files, and storages the historical data according to time in a hard drive, in order to form a set of file sequence, at the same time, another thread judges periodically the state of the second database, if the second database is normal, the other thread accesses and parses the sequence according to the time to obtain its content, and writes the content in the second database, deletes the sequence after successful writing and turns into a next circle, if the second database is not available, the another thread is in the state of loop awaiting.

By utilizing the data recovery unit, the historical data during the fault period can be recovered after the second database returns to normal, thus the continuity and integrity of the data can be ensured.

The invention also provides an apparatus for splitting and recovering data in a power system, which comprises a first database, a data recovery unit DB_SERVICE and a second database.

The first database and the data recovery unit DB-SERVICE are set in the platform layer of the power system, and the first and second databases constitute the whole database environment of the power system.

The first database runs in the memory of the system, which is consisted of the real-time image in the memory of the grid model and static parameters of the second database. The grid model, static parameters and the historical data are stored in the second database.

The access interfaces of the first and second databases are encapsulated in a database access layer.

The first database is used to call corresponding interfaces TableOpen and TableGet thereof to inquire when the database access layer receives a read request to the grid model and the static parameters. The input parameters of TableOpen are const char* app_name and const int table_no, and the input parameter of TableGet is char*field_name, the output parameters of TableGet are char**field_buf_ptr and intbufsize.

The first database is also used to write the real-time data of the first database to the second database as the historical data by means of a synchronization program DB_Modify_Server of the data recovery unit DB_SERVICE.

The second database is used to call corresponding interface SelectSql thereof to inquire by means of the data recovery unit DB_SERVICE when the database access layer receives a read request to the historical data. The input parameter of SelectSql is constchar*sql_str, and the output parameters of SelectSql are TSelectResultStru_outout_select_result and SEQDBErrorStru outout_db_error.

The second database is also used to access grid model and static parameters of the second database to update the first database by means of a synchronization program DB_Modify_Server of the data recovery unit DB_SERVICE.

The data recovery unit DB_SERVICE is responsible for all of the associated read-write operations with the second database. In the data recovery unit DB_SERVICE the accesses of the grid model, static parameters and historical data are encapsulated into different services.

The data recovery unit DB_SERVICE is particularly used to call the main thread of the service process db_commit to write the historical data with time scale characters in different files when it receives a write request, and to store the files according to time in a hard drive, in order to form a set of file sequence. Meanwhile, the data recovery unit DB_SERVICE is also used to call another thread to judge the state of the second database, if the second database is normal, the another thread accesses and parses the sequence to obtain its content, and writes the content into the second database, if the second database is not available, the another thread is into the state of loop awaiting.

As described above, the preferred embodiments of the method and apparatus for splitting and recovering data in a power system of the invention are described in details, however, the invention is not limited to the aforementioned embodiments and implementing methods, many variations and implements can be made within the scope of the invention by those skilled in the related art.

What is claimed is:

1. A method for splitting and recovering data in a power system, comprising:
a database access layer calling interfaces TableOpen and TableGet corresponding to a first database to inquire in the first database when the database access layer receives a read request to a grid model and static parameters, wherein the input parameters of TableOpen are const char* app_name and const int table_no, and the input parameter of TableGet is char*field_name, and the output parameters of TableGet are char**field_buf_ptr and intbufsize, and
the database access layer calling an interface SelectSql corresponding to a second database to inquire in the second database by means of a data recovery unit DB_SERVICE when the database access layer receives a read request to historical data, wherein the input parameter of SelectSql is constchar*sql_str, and the output parameters of SelectSql are TSelectResultStru_outout_select result and SEQDBErrorStru_outout_db_error, wherein
the first database and the data recovery unit DB-SERVICE are set in a platform layer of the power system, and the first database and a second database constitute the whole database environment of the power system,
the first database runs in the memory of the power system, which is consisted of the real-time image in the memory of a grid model and static parameters of the second database,
the grid model, static parameters and historical data are stored in the second database,
the access interfaces of the first and second databases are encapsulated in a database access layer,
the data recovery unit DB-SERVICE is responsible for all of the associated read-write operations with the second database: the data recovery unit DB_SERVICE calling a main thread of a service process db_commit to write the received historical data with time scale characters into different files one by one when it receives a write request, and storing these files in a hard drive according to time to form a set of file sequence, and calling another thread of the service process db_commit to judge the state of the second database, such that the another thread can access and parse the file sequence to write its content to the second database if the second database is normal, or otherwise the another thread be into a state of loop waiting,
the data recovery unit DB-SERVICE calling a synchronization program DB_Modify_Server to write the real-time data from the first database to the second database as the historical data when it receives a synchronization request from the second database, and calling the synchronization program DB_Modify_Server to access the grid model and static parameters of the second database to update the first database when it receives a synchronization request from the first database, and
the accesses of the grid model, static parameters and historical data are encapsulated into different services in the data recovery unit DB_SERVICE.

2. An apparatus for splitting and recovering data in a power system, comprising:
a first database, a data recovery unit DB_SERVICE, and a second database, wherein
the first database and the data recovery unit DB-SERVICE are set in a platform layer of the power system, and the first database and a second database constitute the whole database environment of the power system,
the first database runs in the memory of the power system, which is consisted of the real-time image in the memory of a grid model and static parameters of the second database,
the grid model, static parameters and historical data are stored in the second database,
the access interfaces of the first and second databases are encapsulated in a database access layer,
the first database is used to call its corresponding interfaces TableOpen and TableGet to inquire when the database access layer receives a read request to the grid model and the static parameters, the input parameters of TableOpen are const char* app_name and const int table_no, and the input parameter of TableGet is char*field_name, the output parameters of TableGet is char**field_buf_ptr and intbufsize,
the first database is also used to write the real-time data of the first database to the second database as the historical data by means of a synchronization program DB_Modify_Server of the data recovery unit DB_SERVICE,
the second database is used to call its corresponding interface SelectSql to inquire by means of the data recovery unit DB_SERVICE when the database access layer receives a read request to the historical data, the input parameter of SelectSql being constchar*sql_str, the output parameters being TSelectResultStru_outout_select_result and SEQDBErrorStru_outout_db_error, and the second database is also used to access the grid model and static parameters of the second database to update the first database by means of the synchronization program DB_Modify_Server of the data recovery unit DB_SERVICE,
the data recovery unit DB_SERVICE set in a platform layer of the power system with the first database is responsible for all of the associated read-write operations with the second database, and the data recovery unit DB_SERVICE encapsulates the accesses of the grid model, static parameters and historical data into different services, and
the data recovery unit DB-SERVICE is used for calling a main thread of a service process db_commit to write the received historical data with time scale characters into different files one by one when it receives a write request, and storing these files in a hard drive according to time to form a set of file sequence, and calling another thread of the service process to judge the state of the second database, such that another thread can access and parse the file sequence to write its content into the second database if the second database is normal, or otherwise the another thread be into the state of loop awaiting.
